(19) United States
(12) Patent Application Publication
(10) Pub. No.: US 2019/0251487 A1
(43) Pub. Date: Aug. 15, 2019

(54) METHOD AND SYSTEM FOR AI-DRIVEN & AI-OPTIMIZED DECISIONS, ACTIONS, & WORKFLOWS IN PROCESS OPERATIONS

(71) Applicant: Kumar Srivastava, Mountain View, CA (US)

(72) Inventor: Kumar Srivastava, Mountain View, CA (US)

(21) Appl. No.: 16/395,379

(22) Filed: Apr. 26, 2019

(51) Int. Cl. G06Q 10/06; G06N 5/02

(52) U.S. Cl. CPC G06Q 10/0633; G06N 5/02

(57) ABSTRACT

Disclosed is a method and a system for AI-driven & AI-optimized decisions, actions, & workflows in process operations. The system has the ability to create, update, process, and link tickets automatically. The system can also automatically determine the transactions that should be converted into tickets. The system further processes any generated or created tickets through a set of AI models designed to produce classifications for tickets in real time and appends the AI driven classifications to the tickets. The system can analyze the content of the ticket and assign the ticket automatically to the appropriate ticket queue that is owned by a user or team.

### FIELD OF THE INVENTION

The present invention relates generally to artificial intelligence (AI), and, more particularly, to a method and a system for AI-driven & AI-optimized decisions, actions, & workflows in process operations.

### BACKGROUND

Generally, in business planning and operations, there are several different disconnected systems. Users have separate systems for analysis, separate systems for workflows, and separate systems for taking actions. Typically, business and operational events are collected. Thereafter, offline analytics are used to determine trends, anomalies, success drivers, areas of improvements, and user's needs. Specific business and operational events are mined and searched and analyzed to determine interesting segments and cohorts. Data about these interesting events is then transferred to a data analysis environment for deeper predictive analytics, machine learning, and AI driven analysis. Data scientists then convert this data after data preparation into AI models. These AI models are then deployed into production. AI applications then process the predictions from these AI models through business logic to drive insights and actions in different action systems.

The workflow goes from transactional systems to analytical systems to data science systems to processing systems back to transactional systems. The workflow traverses through business users to analysts to data scientists to software engineers to analysts and then to business users. The workflow traverses several systems, applications, organizational and user boundaries, and hence is slow, manual, error prone, and likely to not complete accurately or within time constraints.

The present invention is about removing these multiple steps in workflows, processes, systems, and users, and enable the business users to perform all key actions to swiftly integrate AI driven actions in their transactional systems.

### BRIEF SUMMARY

It is an objective of the present invention to provide a method and a system for AI-driven & AI-optimized decisions, actions, & workflows in process operations. In an embodiment, the present invention enables users to go from transactional to analytical to predictive to action to transactional scenarios. The present invention aims to automate the following workflows:
1. Customer Transaction Occurs
2. Employees determine if they can act on the transaction
3. Employees enable the transaction
4. If they cannot enable, they create tickets
5. Tickets are worked on by other employees
6. Other employees analyze and generate insights
7. Other employees research the transactions and generate an understanding of what needs to be improved or developed
8. These employees research and generate ideas, discussions and strategies to address these problems
9. These employees generate & research documents and content to support their hypothesis and plans

The system of the present invention has the ability to create, update, process, and link one or more tickets automatically. The system of the present invention can also automatically determine the transactions that should be converted into the one or more tickets. The system of the present invention further processes any generated or created tickets through a set of AI models designed to produce classifications for tickets in real time and appends the AI driven classifications to the tickets. The system of the present invention can analyze the content of the ticket and assign the ticket automatically to the appropriate ticket queue that is owned by a user or team. The one or more tickets are automatically created by observing individual events as they occur in real-time or by observing groups of events that are related or based on the output of AI processing of incoming events and transactions or documents.

The system of the present invention also enables users to create “stories” based on incoming events or automatically creates stories. These stories are made easily available with automatically generated recommendations on how the stories should be acted upon by the recommended users. The system of the present invention also automatically groups and organizes key content around “threads” or related information across multiple event categories. The system of the present invention automatically processes the transactions, and leverages the success, failure, and unmet user need annotations to categorize key transactions as training material into training sets. The system of the present invention automatically generates Knowledge Bases that act as a repository of questions and answers.

These and other features and advantages of the present invention will become apparent from the detailed description below, in light of the accompanying drawings.

### BRIEF DESCRIPTION OF THE ACCOMPANYING DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of various examples. It is expressly understood, however, that the drawings are for the purpose of illustration and description only and are not intended as a definition of the limits of the invention. Embodiments of this invention will now be described by way of example in association with the accompanying drawings in which:

FIG. 1 is a block diagram that illustrates a system environment in which various embodiments of the present invention are practiced;

FIG. 2 show an exemplary block diagram for illustrating the proposed transition, in accordance with an embodiment of the present invention;

FIGS. 3A and 3B show an exemplary block diagram for illustrating a technique for AI-driven & AI-optimized decisions, actions, & workflows in process operations, in accordance with an embodiment of the present invention; and

FIG. 4 is a block diagram that illustrates a system architecture of a computer system for AI-driven & AI-optimized decisions, actions, & workflows in process operations, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. For example, the dimensions of some of the elements in the figures may be exaggerated, relative to other elements, in order to improve the understanding of the present invention. There may be additional components described in the foregoing application that are not depicted on one of the described drawings. In the event such a component is described, but not depicted in a drawing, the absence of such a drawing should not be considered as an omission of such design from the specification.

Before describing the present invention in detail, it should be observed that the present invention utilizes a combination of components, which constitutes methods and systems for AI-driven & AI-optimized decisions, actions, & workflows in process operations. Accordingly, the components have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items.

Techniques consistent with the present invention provide, among other features, methods and systems for AI-driven & AI-optimized decisions, actions, & workflows in process operations. While various exemplary embodiments of the disclosed systems and methods have been described below, it should be understood that they have been presented for purposes of example only, and not limitations. It is not exhaustive and does not limit the invention to the precise form disclosed. Modifications and variations are possible in light of the above teachings or may be acquired from practicing of the invention, without departing from the breadth or scope.

The present invention will now be described with reference to the accompanying drawings, which should be regarded as merely illustrative without restricting the scope and ambit of the present invention.

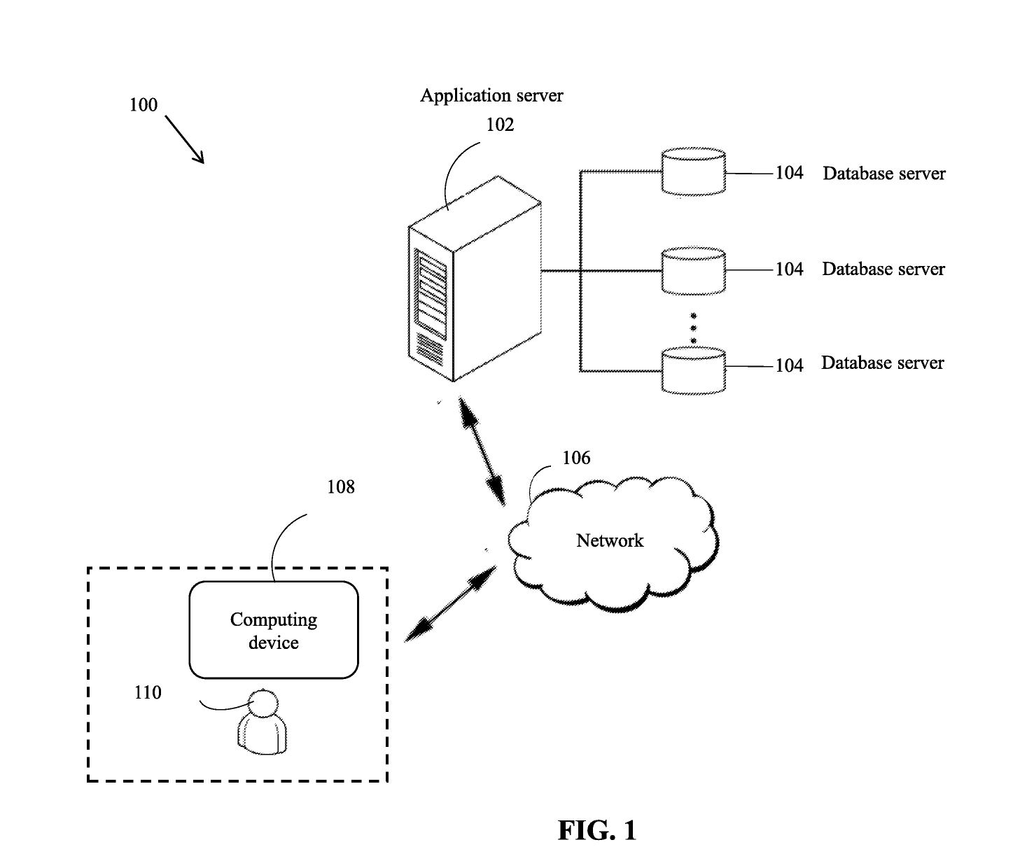

FIG. 1 is a block diagram that illustrates a system environment 100 in which various embodiments of the present invention are practiced. The system environment 100 includes an application server 102, one or more database servers such as a database server 104, and a network 106. The system environment 100 further includes one or more user computing devices associated with one or more users such as a user computing device 108 associated with a user 110. The application server 102 and the user computing device 108 may communicate with each other over a communication network such as the network 106. The application server 102 and the database server 104 may also communicate with each other over the same network 106 or a different network.

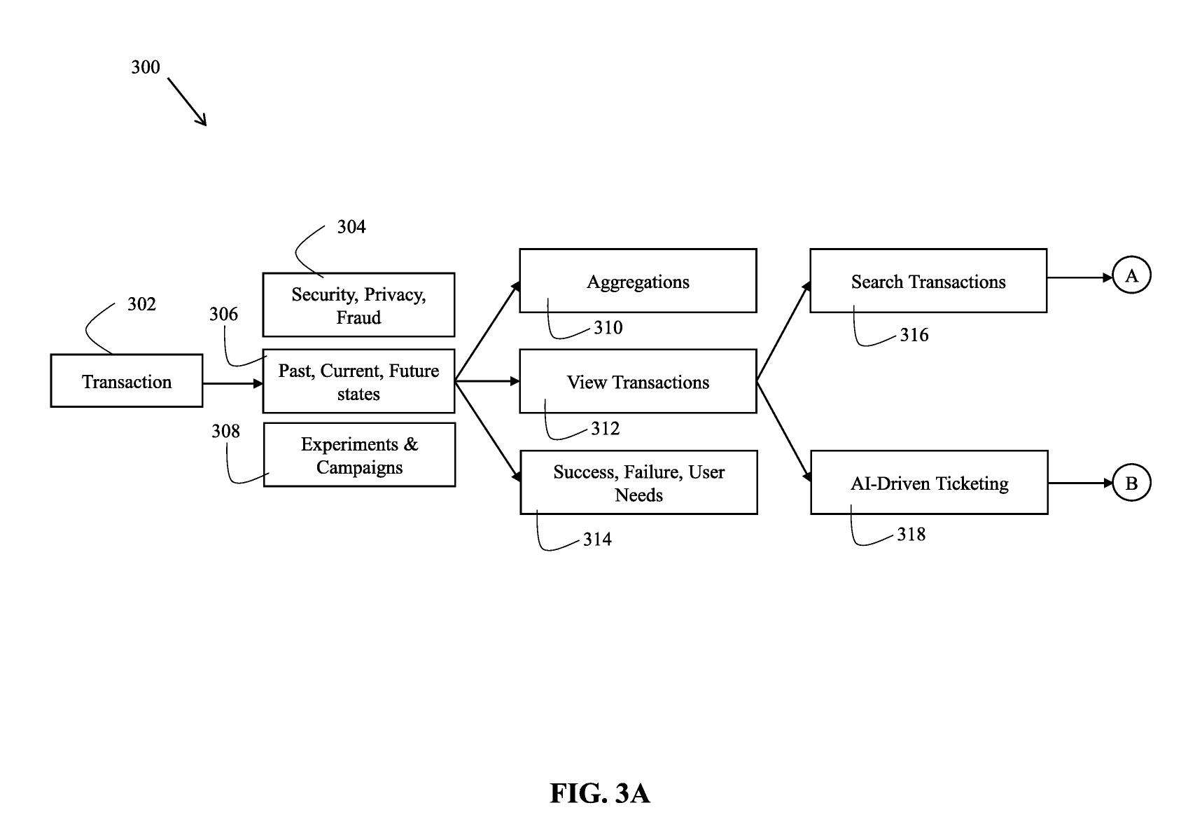

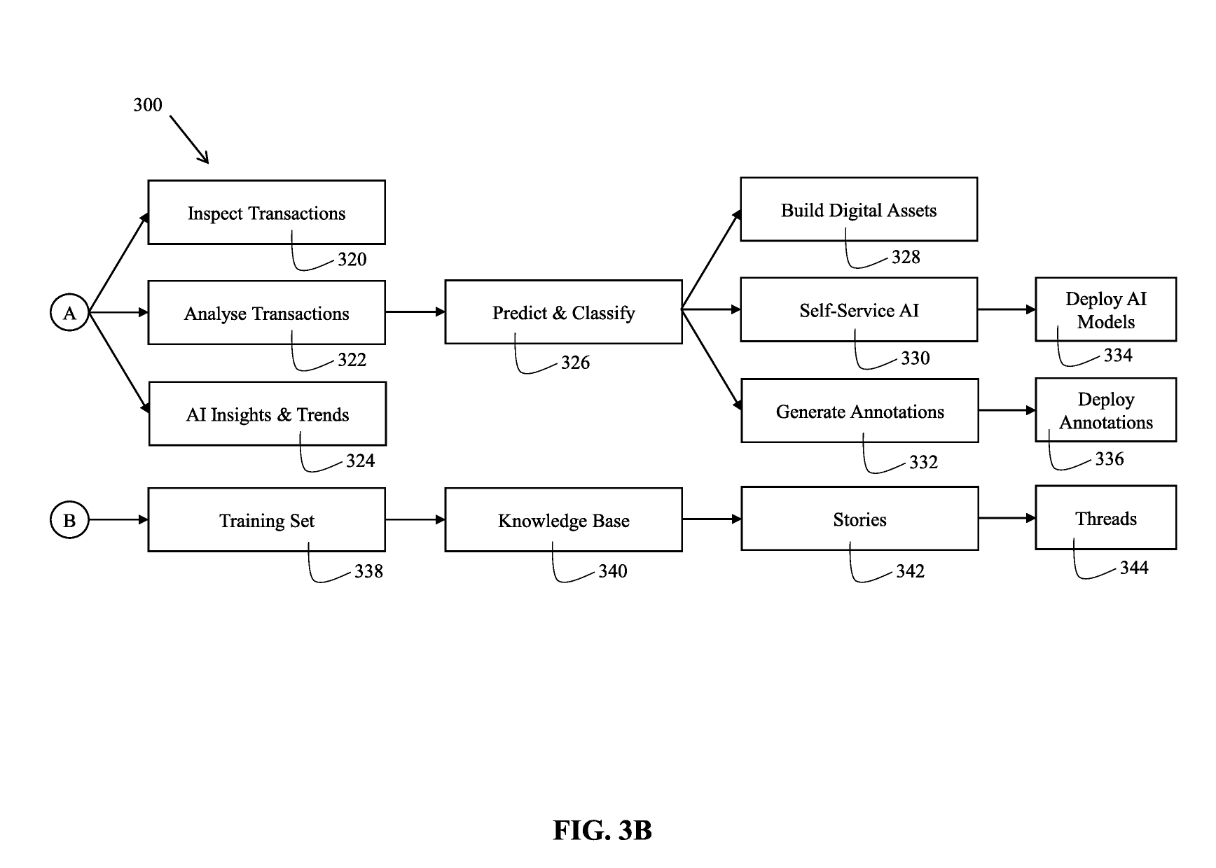

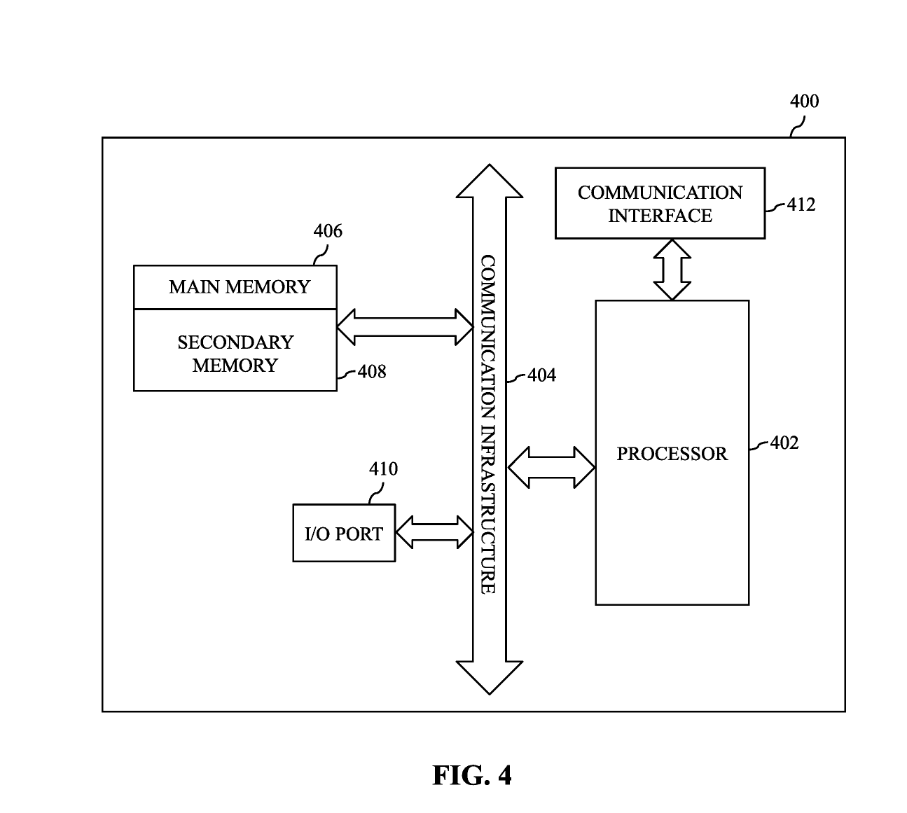

The application server 102 is a computing device, a software framework, or a combination thereof, that may provide a generalized approach to create the application server implementation. Various operations of the application server 102 may be dedicated to execution of procedures, such as, but are not limited to, programs, routines, or scripts stored in one or more memory units for supporting its applied applications and performing defined operations. For example, the application server 102 is configured to create, update, process, and link one or more tickets automatically. The one or more tickets are automatically created by observing individual events as they occur in real-time or by observing groups of events that are related or based on the output of AI processing of incoming events and transactions or documents. The application server 102 is further configured to automatically determine the transactions. The application server 102 is further configured to determine the best user or the best team to assign the ticket. The application server 102 is further configured to automatically convert any event across any event category into a ticket if it is likely that a ticket is needed. The application server 102 is further configured to automatically determine temporal and spatially related tickets with a parent-child relationship and automatically link the tickets and suppress any downstream alerts. The application server 102 is further configured to automatically consolidate and connect the related tickets that are likely to have similar causes and/or resolutions including the type/process of resolution. The application server 102 is further configured to determine if a ticket cannot be automatically resolved and collect the required information and append it to the ticket and deliver it to the assigned party. The application server 102 is further configured to enable the users to create “stories” based on incoming events or automatically creates stories. The application server 102 is further configured to automatically group and organize key content around “threads” or related information across multiple event categories. The application server 102 is further configured to automatically process the transactions, and leverage the success, failure, and unmet user need annotations to categorize key transactions as training material into training sets. The application server 102 is further configured to automatically generate Knowledge Bases that act as a repository of questions and answers. The application server 102 automatically connects and links the tickets, threads, stories, risks, training sets and knowledge bases enabling users to traverse through various information. The application server 102 automatically detects and highlights risks based on analysis of incoming events and transactions or documents that contain signals that are harmful to the involved entities, business, and transaction success likelihood. Various other operations of the application server 102 have been described in detail in conjunction with FIGS. 3 and 4.

Examples of the application server 102 include, but are not limited to, a personal computer, a laptop, or a network of computer systems. The application server 102 may be realized through various web-based technologies such as, but not limited to, a Java web-framework, a .NET framework, a PHP (Hypertext Preprocessor) framework, or any other web-application framework. The application server 102 may operate on one or more operating systems such as Windows, Android, Unix, Ubuntu, Mac OS, or the like.

The database server 104 may include suitable logic, circuitry, interfaces, and/or code, executable by the circuitry that may be configured to perform one or more data management and storage operations such as receiving, storing, processing, and transmitting queries, data, or content. In an embodiment, the database server 104 may be a data management and storage computing device that is communicatively coupled to the application server 102 or the user computing device 108 via the network 106 to perform the one or more operations.

In an exemplary embodiment, the database server 104 may be configured to manage and store one or more default AI models, one or more custom AI models, one or more default business logics, and one or more custom business logics. In an exemplary embodiment, the database server 104 may be configured to manage and store input data such as business event data, customer or user communication data, document data, legacy business data, or the like. In an exemplary embodiment, the database server 104 may be configured to manage and store historical data such as historical event detection data, historical event classification data, historical event projection data, historical event impact data, source configuration data, monitoring data, classifier data, impact prediction data, or the like. In an exemplary embodiment, the database server 104 may be configured to manage and store all event search activity. In an exemplary embodiment, the database server 104 may be configured to manage and store the tickets, transactions, and the associated actions.

In an embodiment, the database server 104 may be configured to receive a query from the application server 102 for retrieval of the stored information. Based on the received query, the database server 104 may be configured to communicate the requested information to the application server 102. Examples of the database server 104 may include, but are not limited to, a personal computer, a laptop, or a network of computer systems.

The network 106 may include suitable logic, circuitry, interfaces, and/or code, executable by the circuitry that may be configured to transmit messages and requests between various entities, such as the application server 102, the database server 104, and the user computing device 108. Examples of the network 106 include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the system environment 100 may connect to the network 106 in accordance with various wired and wireless communication protocols, such as Transmission Control Protocol and Internet Protocol (TCP/IP), User Datagram Protocol (UDP), Long Term Evolution (LTE) communication protocols, or any combination thereof.

The user computing device 108 is a computing device that is utilized by the user 110 to perform one or more user operations. The user computing device 108 may include suitable logic, circuitry, interfaces, and/or code, executable by the circuitry, that may be configured to perform the one or more operations. The user computing device 108 may be configured to run a software application or a web application, hosted by the application server 102, that allows the user 110 to perform the one or more operations. For example, the user 110 uses the user computing device 108 to log-in into the application. Upon log-in, the user 110 uses the user computing device 108 to view a dashboard and specific dashboards for success drivers, areas of improvement, and user needs. The user 110 can pick a time horizon to craft their analysis. The user 110 can have one or more annotations belonging to these categories or can create other annotation categories. On dashboards, the user 110 has the ability to interact with correlations and relationships between various high-quality signals in their data set. The user 110 is able to view the correlations and distributions between any two attributes of the data set. The user 110 is also able to view an analysis of various attributions sorted by signal strength and distribution frequency analysis. The user 110 is also able to view a collection of default AI driven analysis for the set of events on the dashboards including keyword analysis, topic analysis, entity analysis, PII analysis, knowledge graph visual, knowledge base visual, and security analysis. The user 110 can proceed to see the entire list of events or list of events with a specific annotation. The user 110 can filter and search through events using both event properties and AI driven properties. The user 110 can proceed to select a set of events as a result of their search & filtering activity. The user 110 can proceed to view analytics of these selected events. The user 110 can then proceed to view AI powered analytics of those events including forecasts, spikes, anomalies, change analysis, aggregate analysis, and temporal analysis. The user 110 can interact with the provided visualizations and select certain parts of the visualization and trigger the creation of AI models or business rules that are deployed as annotations for real time processing. The user 110 can then proceed to create self-service Ai from this data set including topic modeling, word-based clustering, document-based clustering, NPL AI modeling, and anomaly definition. For each of the above capabilities, the user 110 can create new annotations using the output of the functionality and deploy the AI output for real-time event annotation. The user 110 can further manage their real-time event annotations and enable or disable them. The user 110 can also build AI assets including APIs, Bots, analytics & dashboards, knowledge base, training set, and developer & partner portals. Various other operations of the user computing device 108 and the user 110 have been described in detail in conjunction with FIGS. 3 and 4.

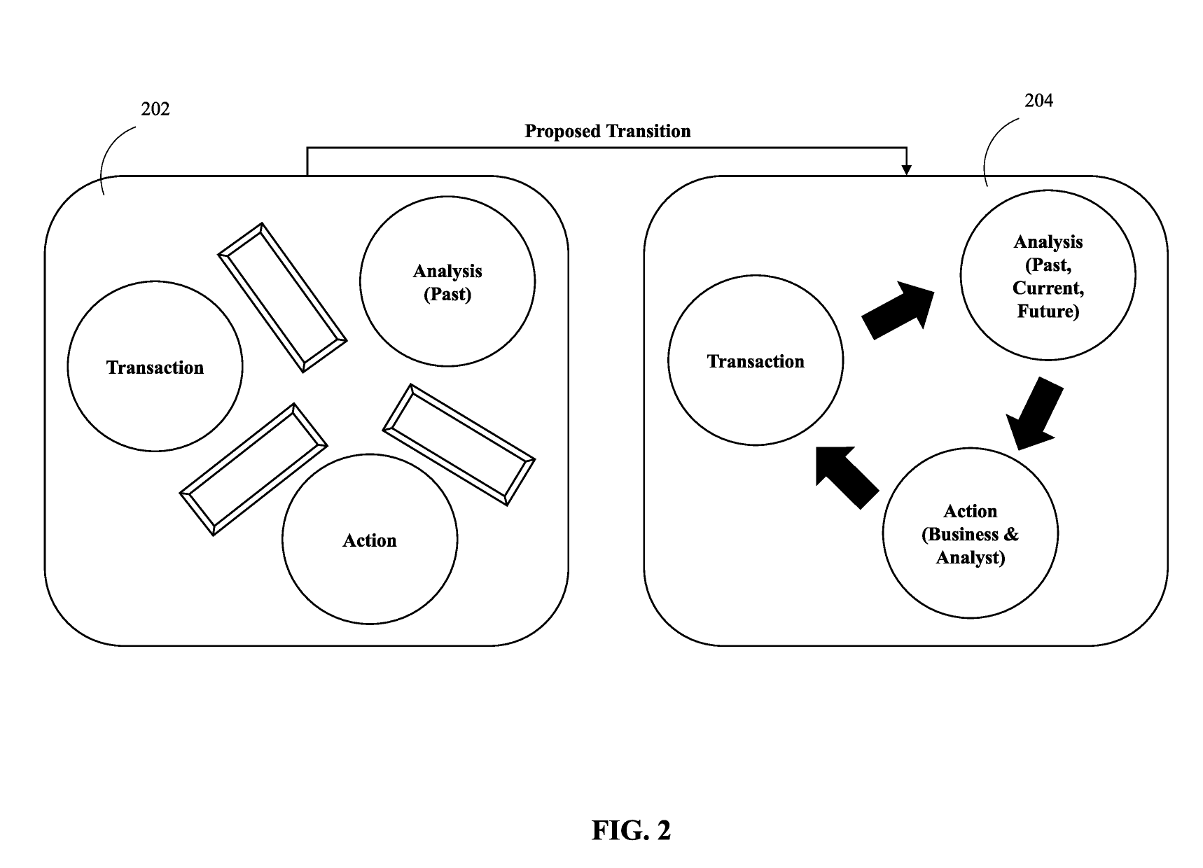

FIG. 2 show an exemplary block diagram for illustrating the proposed transition, in accordance with an embodiment of the present invention. In the current scenario 202, the process of transactions is not captured and analyzed in the real-time. Further, there exists disparate systems, causing users data in silos and locked conditions. Historical, offline, and rear-view analytics are also missing. This leads to missed opportunities for corrective actions. As a result, analysts and business users are unable to act efficient and effectively on time. Further, various activities of employees or users are not captured. Missing feedback loop reduces agility. Currently, manual processes are being integrated with few machine learning platforms to optimize the decisions, actions, & workflows in process operations. These processes are often tedious and slow and can take too long at the cost of delays in building the best possible models. With the proposed scenario 204, the transactions are analyzed with AI in the real-time. Further, the analysis, search, inspection, and linking are automatically performed. This causes automated AI-driven recommendations, self-service AI, and dynamic, real-time annotations, and AI deploy. This further leads to predictive ticketing, workflows, queues, and automation. Also, the proposed scenario 204 facilitates AI driven by annotations, experimentation, and hypothesis testing.

FIGS. 3A and 3B show an exemplary block diagram 300 for illustrating a technique for AI-driven & AI-optimized decisions, actions, & workflows in process operations, in accordance with an embodiment of the present invention. At 302, the transactions are automatically determined that should be converted into tickets. At 304, security, privacy, and fraud analysis are performed. At 306, past, current, and future states are analyzed. At 308, experiments and campaigns are performed. At 310, the aggregation of data is performed. At 312, the transactions are viewed using one or more dashboards. At 314, the application server 102 automatically processes transactions and leverages the success, failure and user needs annotations to categorize key transactions as training material into training sets. At 316, the transactions are searched. The application server 102 utilizes user activity and interaction with the transactions or documents to automatically annotate and learn to enable future automation. At 318, the AI-driven ticketing is obtained. At 320, the transactions are inspected. At 322, the transactions are analyzed. At 324, the AI insights and trends are generated. At 326, prediction and classification are performed. At 328, the digital assets are built. At 330, the self-service AI is created from the data set. At 332, the annotations are generated. At 334, the AI models are deployed. At 336, the annotations are deployed. At 338, the training sets are automatically or manually curated with new transactions and how these transactions are serviced by employees. The training Sets enable new users to be trained by accessing and reviewing the transactions. At 340, the application server 102 automatically generates knowledge bases that act as a repository of questions and answers both automatically generated using NLP techniques and manually created by users. The knowledge bases include questions whose answers are found in various transactions. All transactions are processed to generate knowledge base questions and these questions are then added to the knowledge base. At 342, the application server 102 enables the users to create “stories” based on incoming events or automatically creates stories and these stories are made easily available with automatically generated recommendations on how the stories should be acted upon by the recommended users. At 344, the application server 102 automatically groups and organizes key content around “threads” or related information across multiple event categories. Threads are streams of information related to a specific idea which could be a set of keywords, or user or customer or a topic. Threads are automatically and constantly updated as new transactions are created or arrive and are found to be similar, related to or linked to the thread. The threads are editable i.e., the users can spawn discussions on information in the thread and generate new content in the thread. The application server 102 can also automatically processes the thread using various AI models and generates recommendations for the thread users to act, investigate and maintains a thread summary and thread profile. The application server 102 tracks the usage of threads and interaction of users with threads and within threads to generate a ranking of threads by quality and value and recommend threads to various users based on the user's interaction with other content and transactions.

FIG. 4 is a block diagram that illustrates a system architecture of a computer system 400 for AI-driven & AI-optimized decisions, actions, & workflows in process operations, in accordance with an embodiment of the present invention.

An embodiment of the present invention, or portions thereof, may be implemented as computer readable code on the computer system 400. In one example, the application server 102 of FIG. 1 may be implemented in the computer system 400 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3A and 3B. The computer system 400 includes a processor 402 that may be a special purpose or a general-purpose processing device. The processor 402 may be a single processor, multiple processors, or combinations thereof. The processor 402 may have one or more processor “cores.” Further, the processor 402 may be connected to a communication infrastructure 404, such as a bus, a bridge, a message queue, the network 106, multi-core message-passing scheme, and the like. The computer system 400 further includes a main memory 406 and a secondary memory 408. Examples of the main memory 406 may include RAM, ROM, and the like. The secondary memory 408 may include a hard disk drive or a removable storage drive (not shown), such as a floppy disk drive, a magnetic tape drive, a compact disk, an optical disk drive, a flash memory, and the like. Further, the removable storage drive may read from and/or write to a removable storage device in a manner known in the art. In an embodiment, the removable storage unit may be a non-transitory computer readable recording media. The computer system 400 further includes an input/output (I/O) port 410 and a communication interface 412. The I/O port 410 includes various input and output devices that are configured to communicate with the processor 402. Examples of the input devices may include a keyboard, a mouse, a joystick, a touchscreen, a microphone, and the like. Examples of the output devices may include a display screen, a speaker, headphones, and the like. The communication interface 412 may be configured to allow data to be transferred between the computer system 400 and various devices that are communicatively coupled to the computer system 400. Examples of the communication interface 412 may include a modem, a network interface, i.e., an Ethernet card, a communications port, and the like. Data transferred via the communication interface 412 may be signals, such as electronic, electromagnetic, optical, or other signals as will be apparent to a person skilled in the art. The signals may travel via a communications channel, such as the network 106, which may be configured to transmit the signals to the various devices that are communicatively coupled to the computer system 400. Examples of the communication channel may include, but not limited to, cable, fiber optics, a phone line, a cellular phone link, a radio frequency link, a wireless link, and the like. Computer program medium and computer usable medium may refer to memories, such as the main memory 406 and the secondary memory 408, which may be a semiconductor memory such as dynamic RAMs. These computer program mediums may provide data that enables the computer system 400 to implement the present invention. In an embodiment, the present invention is implemented using a computer implemented application. The computer implemented application may be stored in a computer program product and loaded into the computer system 400 using the removable storage drive or the hard disk drive in the secondary memory 408, the I/O port 410, or the communication interface 412.

Workflow

User (such as the user 110) logs into an application. The user goes into the application. An application jurisdiction is over one or more specific event categories. The user views a dashboard and specific dashboards for success drivers, areas of improvement, and user needs. The dashboards are driven by annotation and time that are either industry specific and provided by the system (such as the application server 102) or defined by users.

Annotations can be keywords or labels in combination logic AND/OR/NOT, regular expressions, search queries, AI Models, and anomaly definitions. The user 110 can pick a time horizon to craft their analysis.
1. Rear View AI
2. Real-time AI
3. Future AI

Annotations are organized in one or more high level categories selected from a group comprising:
1. Success
2. Failure
3. User Needs
4. Training Set
5. Knowledge Base
6. Anomalies
7. Stories
8. Risks
9. Threads

Users (such as the user 110) can have one or more annotations belonging to at least one of these nine categories or can create other annotation categories. Each of these dashboards analyzes the key KPIs critical for the app objectives. Each of these dashboards selects the relevant events given the annotations selected by default for that dashboard or selected by the user 110. On these dashboards, the user 110 has the ability to interact with correlations and relationships between various high-quality signals in their data set. The user 110 is able to view the correlations and distributions between any two attributes of the data set. The user 110 is also able to view an analysis of various attributions sorted by signal strength and distribution frequency analysis. Users are also able to view a collection of default AI driven analysis for the set of events on the dashboards including:
1. Keyword analysis
2. Topic analysis
3. Entity Analysis
4. PII Analysis
5. Knowledge Graph Visual
6. Knowledge Base Visual
7. Security Analysis
8. Content Type Classification
9. Industry Type Classification
10. Intent Type Classification
11. Persona Type Classification
12. Service Ticket Type Classification (19 parameters)
13. Legal Clauses Extractor
14. Legal Type Classification
15. Legal Summarization
16. Default Summarization
17. Healthcare Type Classification
18. Interaction Type Classifier

The user 110 can proceed to see the entire list of events or list of events with a specific annotation. The user 110 can filter and search through events using both event properties and AI driven properties. The user 110 can proceed to select a set of events as a result of their search & filtering activity. The user 110 can proceed to view analytics of these selected event. The user 110 can then proceed to view AI powered analytics of those events including:
1. Forecasts
2. Spikes
3. Anomalies
4. Change Analysis
5. Aggregate Analysis
6. Temporal Analysis

Users can interact with the provided visualizations and select certain parts of the visualization and trigger the creation of AI models or business rules that are deployed as annotations for real time processing. The user 110 can then proceed to create self-service AI from this data set including:
1. Topic Modeling
2. Word-based Clustering
3. Document-based Clustering
4. NPL AI Modeling
5. Anomaly Definition
6. Keyword-Attribute Value Correlation
7. Association Set Determination

For each of the above capabilities, the user 110 can create new annotations using the output of the functionality and deploy the AI output for real-time event annotation. Users can manage their real-time event annotations and enable/disable them. Users can also build AI assets including:
1. APIs
2. Bots such as Information Bots and Chat Bots
3. Analytics & Dashboards
4. Knowledge Base
5. Training Set
6. Developer & Partner Portals

The application server 102 aims to automate the following workflows:
1. Customer Transaction Occurs. The customer's intent, sentiment, needs and goals are automatically determined and accordingly, the transaction is processed. If the transaction cannot be automatically processed, one or more employees or groups of employees are notified.
2. Employees determine if they can act on the transaction
3. Employees enable the transaction
4. If they cannot enable, they create tickets
5. Tickets are worked on by other employees
6. Other employees analyze and generate insights
7. Other employees research the transactions and generate an understanding of what needs to be improved or developed (“stories”)
8. These employees research and generate ideas, discussions and strategies to address these problems collaboratively (“threads”)
9. These employees generate & research documents and content to support their hypothesis and plans

The application server 102 has the ability to create, update, process and link tickets automatically. The user 110 can pick any event from the list at any point in the above workflow and convert it into a ticket. The user 110 can define various ticket parameters including type, category, severity, priority and other annotations as needed. The application server 102 can also automatically determine the transactions that should be converted into tickets and can convert them into tickets. The application server 102 processes any generated or created tickets through a set of AI models designed to produce classifications for tickets in real time and appends the AI driven classifications to the tickets
a. Reported Source
b. Product Element
c. Resolution Method
d. Service Classification
e. Resolution Service Element
f. Resolution Service Type
g. Resolution Service Category
h. Cause Category
i. Level1Resolution
j. Level2Resolution
k. Product Category
l. Product Type
m. Product Element
n. Priority
o. Cause Type
p. Service Category
q. Resolution Product Category
r. Resolution Product Type

The application server 102 can analyze the content of the ticket and assign the ticket automatically to the appropriate ticket queue that is owned by a user or team. The application server 102 uses the following information as input to determine who to assign the ticket:
a. The type of ticket (Information Request, Diagnosis, Complaint, Feature Request, Bug, Enhancement Request, Product Idea, Incident Report, Watchlist)
b. The category of ticket (App specific category)
c. The priority of ticket
d. The severity of ticket
e. The workflow that the ticket should follow

The application server 102 uses the following to determine the best user/team to assign the ticket:
1. The user/team most likely assigned to tickets of this type and category and priority
2. The user/team most likely to close such tickets successfully

When The application server 102 is not sure, it can ask the user 110 to approve/disapprove the ticket assignment. The user 110 can also choose to specify the assignment itself. The application server 102 can automatically convert any event across any event category into a ticket if it is likely that a ticket is needed. The application server 102 can automatically find temporal and spatially related tickets with a parent-child relationship and automatically link the tickets and suppress any downstream alerts. The application server 102 can automatically consolidate and connect related tickets that are likely to have similar causes and/or resolutions including the type/process of resolution. The application server 102 can automatically resolve a ticket if the likely resolution requires a series of API proxy/service executions. The application server 102 determines if a ticket cannot be automatically resolved and collects the required information and appends it to the ticket and delivers it to the assigned party. Users resolving/processing tickets are required to provide the following:
1. Information required/investigated for the ticket
   a. Source
      i. Type (content|expert|system)
   b. Address
   c. Author
   d. Last Updated Date
   e. Relevant Text/Data
2. Steps taken to resolve the ticket
   a. Forms Submitted
   b. Systems Config Updated
   c. Emails & IM Sent including target
3. Who is required to resolve the ticket
   a. Users/Domain Experts
   b. APIs
   c. Forms including address/location of the form

The application server 102 also monitors tickets to determine the tickets that are
1. Likely to not resolve on time
2. Likely to not resolve
3. Likely to be resolved incorrectly

For each ticket, The application server 102 assigns the ticket to the best team/user as determined according to the next step required by the workflow assigned to the ticket The application server 102 also enables users to create “stories” based on incoming events or automatically creates stories and these stories are made easily available with automatically generated recommendations on how the stories should be acted upon by the recommended users. The application server 102 determines incoming transactions or groups of transactions through processing as signals of product/service gaps or areas of improvement as they signify unmet user needs or suboptimal experience. The application server 102 automatically generates these stories and assigns these stories to the appropriate queue belonging to a team/user. The application server 102 automatically recommends users who should be involved in the story and notifies them based on the activity of the user in the system and their interaction with various transactions or content. The application server 102 automatically creates a virtual team of all recommended users with a unique queue and assigns the story to that team/queue. The application server 102 automatically monitors how the story is processed, acted upon and worked on and generates status notifications, alerts and processing recommendations for the teams including highlighting and linking with other similar stories.

The application server 102 also automatically groups and organizes key content around “threads” or related information across multiple event categories. Threads are streams of information related to a specific idea which could be a set of keywords, or user or customer or a topic. The application server 102 automatically detects topics or keywords or entities that are popular or present across multiple transactions of different types and creates a thread. Users can also explicitly create threads. Threads are automatically and constantly updated as new transactions are created or arrive and are found to be similar, related to or linked to the thread. The threads are editable i.e., users can spawn discussions on information in the thread and generate new content in the thread. The application server 102 also automatically processes the thread using various AI models and generates recommendations for the thread users to act, investigate, and maintain a thread summary and a thread profile. The application server 102 tracks the usage of threads and interaction of users with threads and within threads to generate a ranking of threads by quality and value and recommend threads to various users based on the user's interaction with other content and transactions. The application server 102 tracks the discussions in the thread and determines the status of the thread (i.e. either open, closed, decision made, decision pending, abandoned) and provides these insights to users. The application server 102 also generates related, similar or linked determinations in threads and recommends either merging or linking threads when needed.

The application server 102 automatically processes transactions and leverages the success, failure and unmet user need annotations to categorize key transactions as training material into training sets. Training Sets are automatically or manually curated with new transactions and how these transactions are serviced by employees. Training sets enable new employees to be trained by accessing and reviewing the transactions in these sets. Training sets also enable employees to replay a transaction and test their ability to service the transaction. The application server 102 simulates the incoming transaction from the user and the trainee is able to provide an answer. The trainee's answer is then validated by comparing it with the response in the training set. The application server 102 determines automatically when and which employees should be trained on a particular set of transactions based on the time between trainings, the quality of an employee's current transaction handling, the likelihood of an employee successfully dealing with transactions and the other content/transactions/information that the employee typically is involved with including connection to stories & threads. The application server 102 tracks the usage of training sets by employees and generates a ranking of value and quality of the training set and its ability to improve user quality.

The application server 102 automatically generates Knowledge Bases that act as a repository of questions and answers both automatically generated using NLP techniques and manually created by users. Knowledge Bases contain questions whose answers are found in various transactions. All transactions are processed to generate knowledge base questions and these questions are then added to the knowledge base. The application server 102 also generates a knowledge graph by processing all transactions and generates a graph that connects transactions of disparate types. The application server 102 enables the user to navigate through determined concept relationships between disparate transactions to discover related, similar and linked transactions. The application server 102 also generates an organization wide knowledge base and knowledge graph that automatically becomes the central point for search and discovery for all content and transactions arriving into the organization. The usage of knowledge bases and graphs is fed back into the system to generate a ranking of quality and value for all content/transactions in the system. These rankings are used to surface high quality content and questions to users who would be interested in that content given their interaction with transactions and content.

When a new transaction arrives into the system, the application server 102 determines if the transaction requires corrective or follow up action, and generates a ticket with multiple predictions to enable faster resolution of the ticket. This ticket is assigned to the appropriate user/team queue. The application server 102 automatically performs actions to enable the successful processing of the transaction or customer request. The automated actions are determined through either configuration or observance of previous manual actions from employees or through the ability of the system to learn the appropriate actions through Machine Learning training. The application server 102 further determines if the transaction represents a success or failure and can serve as a useful, high quality training material and automatically assigns the transaction to a training set. The application server 102 further determines if the transaction represents an anomaly and automatically assigns it to the system time anomalies. The application server 102 further determines if the transaction represents an unmet need, or gap or inefficiency and automatically generates a story and assigns the story to the appropriate user/team queue. The application server 102 further determines if the transaction can provide context to an ongoing conversation or should be created into a new conversation and consequently, creates or updates a new “thread”. The application server 102 further determines if a story or ticket should be included in a given thread and whether a thread can be inserted into the knowledge base. The application server 102 further determines if a knowledge base has a question or a thread or a story or a training set has content that a user would be interested in.

Other Capabilities

Immutable Search History for Audit

All event search activity is automatically recorded in an immutable store for full transparency and auditability.

Inspectable Semantic Metadata Layer Built Using AI

All AI driven classifications, categorizations, and labeling is recorded in the system at the time of first-time document and event processing. All generated metadata is searchable, query able and analyzable at any point of time.

Search Journey Capture & Replay

The system enables the capture of the entire search journey and enables a replay of the journey to enable users (for example, examiners) to view comprehensiveness and extent of the search.

Ensemble AI & Analytical Techniques for Cross Examination & Explain Ability

The system leverages multiple search, AI and analytical techniques in parallel with several techniques that can be used to explain the reasoning behind certain determinations and classifications.

AI Driven Search Journeys

The system leverages the following techniques to bring state-of-the-art AI, Search, Graphs, Profiling, AutoML and Collaboration techniques to create a comprehensive search journey.

User Profiling

The system/application is able to profile the user searches performed by a particular user and based on the patterns determined in the types of searches by the user, the user's profile is updated to reflect the categories and keywords typically searched for or examined by that user. This is referred to the “Profile Type”. The profile type of a user is then leveraged to uncover, retrieve and recommend additional documents to the user performing the search. The search history of other users with similar profile types are leveraged to broaden the search.

User Behavior

In addition, the system analyzes the search behavior of users specifically tracking the query parameters, the search results and the interaction of the user with each of the search results. Using explicit capabilities such as “bookmarking” or “annotations” or implicit behavior such as “time spent examining a search result”, the system develops an understanding of the quality of its search results.

User behavior is in turn processed to determine
Related or similar search queries: A search is automatically expanded to include other related or similar search queries
Documents deemed as highly relevant based on previous user behavior or behavior of other similar users (implicit and explicit) are presented with higher ranking

Document Category Driven Search

In addition, the system leverages past search behavior and its internal AI driven categorization to organize documents into clusters based on their proximity or relevance to particular search queries. The system also applies a temporal weight to this organization ensuring that more recently published and examined documents are more likely to show up in relevant searches.

Document Linking & Ticketing Approach

The system facilitates and enables a more structured search process by offering three key capabilities
Automatically Saved & Re-playable Search Behavior & Activity
   A user's personal search activity is automatically recorded and made available for viewing and replaying allowing the user to go on tangential searches and be able to back trace their steps to a previous point.
   In addition, search activity of other users is also available for viewing and inspection
Inbuilt annotation, aggregation & ticketing for tracking tangential searches
   Users are able to annotate documents and choose to deploy these annotations for real-time new document classification or execute similar searches. Annotations can be keywords, regular expressions or Boolean logic.
   In addition, users can search and identify a group of documents and use that to generate representative metadata and convert this metadata into annotations for both search and real-time annotation of new documents. This enables the creation of “category authorities” i.e. group of documents that represent a certain category and can be collectively used to find other similar documents.
   Users can also create tickets to create tasks or actions for them or other users enabling the distribution of search activity by leveraging a divide and conquer strategy
   User activity is automatically leveraged to improve AI modeling ensuring that the system learns and improves over time. The user activity and interaction with the transactions or documents are utilized to automatically annotate and learn to enable future automation.
Inline, self-service AI driven analytical analysis for deeper searches
   System also enables users to train & create new AI models to better classify documents to help in their searches. The system leverages AutoML and a simplified, one click user experience to enable rapid development and usage of AI driven classification. This includes self-service categorization through topic modeling, word-based clustering, document clustering and NLP driven classifiers.

Although particular embodiments of the invention have been described in detail for purposes of illustration, various modifications and enhancements may be made without departing from the spirit and scope of the invention.

What is claimed is:

1. A system, comprising:
circuitry configured to:
automatically determine transactions or documents and convert them into one or more tickets;
process the one or more tickets automatically through a set of AI models designed to produce classifications for the one or more tickets in real time and appends the AI driven classifications to the one or more tickets;
analyze content of the one or more tickets and assign the one or more tickets automatically to the appropriate ticket queue that is owned by a user or a team; and
monitor the one or more tickets to determine the one or more tickets that are likely to not resolve on time, likely to not resolve, and likely to be resolved incorrectly, wherein, for each ticket, the circuitry assigns the one or more tickets to the best team or user for successful resolution.

2. The system of claim 1, wherein the user can pick any event from a list at any point in the above workflow and convert it into a ticket, and wherein the user can define various ticket parameters including type, category, severity, priority and other annotations as needed.

3. The system of claim 1, wherein the circuitry is further configured to use the following to determine the best user or team to assign the one or more tickets: the user or team most likely assigned to tickets of this type and category and priority and the user or team most likely to close such tickets successfully.

4. The system of claim 1, wherein the circuitry is further configured to allow, when the system is not sure, the user to approve or disapprove the ticket assignment.

5. The system of claim 1, wherein the one or more tickets automatically created by observing individual events as they occur in real-time or by observing groups of events that are related or based on the output of AI processing of incoming events and transactions or documents.

6. The system of claim 5, wherein the circuitry is further configured to automatically find temporal and spatially related tickets with a parent-child relationship and automatically link the tickets and suppress any downstream alerts.

7. The system of claim 5, wherein the circuitry is further configured to automatically consolidate and connect related tickets that are likely to have similar causes and/or resolutions including the type/process of resolution.

8. The system of claim 6, wherein the circuitry is further configured to automatically resolve a ticket if the likely resolution requires a series of API proxy/service executions.

9. The system of claim 1, wherein the circuitry is further configured to enable one or more users to create “stories” based on incoming events or automatically creates stories, wherein the stories are made easily available with automatically generated recommendations on how the stories should be acted upon by the recommended users.

10. The system of claim 8, wherein the circuitry is further configured to determine incoming transactions or groups of transactions through processing as signals of product/service gaps or areas of improvement as they signify user needs or suboptimal experience.

11. The system of claim 9, wherein the circuitry is further configured to generate the stories and assign these stories to the appropriate queue belonging to the team or user, and wherein the circuitry automatically connects and links the tickets, threads, stories, risks, training sets and knowledge bases enabling users to traverse through various information.

12. The system of claim 10, wherein the circuitry is further configured to automatically recommend users who should be involved in the story and notify them based on the activity of the users in the system and their interaction with various transactions or content.

13. The system of claim 11, wherein the circuitry is further configured to automatically create a virtual team of all recommended users with a unique queue and assign the story to that team or queue, and wherein the circuitry is further configured to utilize user activity and interaction with the transactions or documents to automatically annotate and learn to enable future automation.

14. The system of claim 12, wherein the circuitry is further configured to automatically monitor how the story is processed, acted upon and worked on and generate status notifications, alerts and processing recommendations for the teams including highlighting and linking with other similar stories.

15. The system of claim 1, wherein the circuitry is further configured to automatically group and organize key content around threads or related information across multiple event categories.

16. The system of claim 14, wherein the circuitry is further configured to automatically process the thread using various AI models and generate recommendations for the thread users to act, investigate and maintain a thread summary and thread profile.

17. The system of claim 15, wherein the circuitry is further configured to track the usage of threads and interaction of users with threads and within threads to generate a ranking of threads by quality and value and recommend threads to various users based on the user's interaction with other content and transactions.

18. The system of claim 1, wherein the circuitry is further configured to automatically process transactions and leverage the success, failure and unmet user need annotations to categorize key transactions as training material into training sets.

19. The system of claim 1, wherein the circuitry is further configured to automatically generate Knowledge Bases that act as a repository of questions and answers both automatically generated using NLP techniques and manually created by users.

20. The system of claim 1, wherein the circuitry is further configured to automatically detect and highlight risks based on analysis of incoming events and transactions or documents that contain signals that are harmful to the involved entities, business, and transaction success likelihood.
